(19) United States
(12) Patent Application Publication
(10) Pub. No.: US 2019/0358659 A1
(43) Pub. Date: Nov. 28, 2019

(54) DEVICE FOR SUPPLYING AN APPLICATION MATERIAL

(71) Applicant: EISENMANN SE, Boblingen (DE)

(72) Inventor: Herbert Schulze, Aidlingen (DE)

(21) Appl. No.: 16/536,461

(22) Filed: Aug. 9, 2019

Related U.S. Application Data
(63) Continuation of application No. 14/916,360, filed on Mar. 3, 2016.

(30) Foreign Application Priority Data
Sep. 3, 2013 (DE) 10 2013 014 669.0

(51) Int. Cl. B05B 12/08; B05C 11/10; B05B 12/00; B05B 12/14

(52) U.S. Cl. CPC B05B 12/08; B05C 11/1042; B05C 11/10; B05B 12/00; B05B 12/14; B05C 11/1002

(57) ABSTRACT

An application system for viscous or pasty media having a conveyor unit which suctions application material from a storage container and feeds the application material under high pressure to an application unit. The conveyor unit and modification circuits inserted in the lines through which application material flows are each provided with local controllable closed-loop control units that receive only set values for a mode of operation from a central open-loop control unit.

### RELATED APPLICATIONS

This application is continuation of U.S. patent application Ser. No. 14/916,360 filed Mar. 3, 2016, which is a national phase of International Patent Application No. PCT/EP2014/002173, filed Aug. 7, 2014, which claims the filing benefit of German Patent Application No. 10 2013 014 669.0, filed Sep. 3, 2013—the contents of all of which are incorporated herein by reference.

### FIELD OF THE INVENTION

The present invention relates to a device for providing an application material.

### BACKGROUND OF THE INVENTION

Many workpieces have to be coated completely or on parts of their boundary surfaces with a material which guarantees certain surface properties of the finished product. Typical examples of this are anti-drumming means, paints, insulating materials and materials which predetermine the behaviour of the surface to certain chemical substances. To apply these materials, use is made of various technical methods, which are to be understood here generally under application methods. These include in particular spraying methods and other coating methods.

Typically, application systems comprise a storage container or a supply line for providing the application material, a conveying unit for conveying the application material from the storage container/supply line (together: material source) to the place of use, in which typically also an increase of the pressure which the application material is under takes place, an application unit which applies the material to workpieces to be coated and typically also conditioning or modification units which condition or modify, e.g. heat, the material.

For the application materials considered primarily here, paints, waxes, adhesives, anti-drumming compounds, underbody protection compounds, sealing compounds, use is made of feed pumps which are suitable for feeding pasty, gel-like or highly viscous materials.

Primarily also the mass production of workpieces is contemplated here, in particular the coating of vehicle components. The word application is to be understood in the context of different types of workpieces and irrespective of the initial processing state of the workpiece. For example, adhesive uses on unfinished components as well as adhesive uses on finished components (e.g. gluing a pane into a vehicle body) are included in the term application.

In the mass production of vehicles or vehicle components as well as in the mass production of other products (such as refrigerators), the application units work cyclically. They apply material for a preset period of time to a workpiece or a workpiece section. There then follows a break in which a new workpiece is moved up to the application unit or a new relative position between the workpiece just processed and the application unit is set. And then the applying of material continues. In these relatively short breaks the application unit does not operate.

In many manufacturing plants it is also the case that their operation is stopped regularly over a longer period of time, e.g. over night.

In these phases of non-working, certain basic procedures must be maintained to enable a restart of the application unit or the entire application system after a break without problems. This means in particular that clogging of lines which deliver the application material must be avoided. The kind of basic procedures here depends usually on the duration of the interruption of the application. Kind here is understood to mean the totality of the parameters describing the basic procedure.

WO 2012/045380 A1 discloses an application system in which a pump unit has a plurality of modes of operation, one in which the processing material is circulated under lower pressure through the lines of the system to keep them free, and a second in which the processing material is provided under high pressure. Individual application units are assigned control units which cooperate with a coordination controller which control regulators arranged in the lines and various sources for processing material.

### SUMMARY OF THE INVENTION

The present invention is intended to simplify the control of such an application system having a plurality of modes of operation.

This object may be achieved according to the invention by a device for providing an application material having, for example, modification units which have a plurality of discrete modes of operation which are individually settable by a control signal. Each modification unit may include a controllable regulating unit which each set, check and maintain a corresponding operating parameter according to a received control signal, and the regulating unit has a memory, in which control signals for the modification units for different modes of operation are stored.

In the application device according to the invention the different modification units have an assigned controllable regulating unit and can thus set, and/or maintain and/or end a preset mode of operation by themselves. To program the individual modification units it is sufficient to supply these with a digital control signal which represents the respectively desired mode of operation.

The coordination of the operation of the different modification units is also simplified by a central controller, since this controller only needs to deliver the control signals for the modes of operation of the modification units and only has to monitor whether the different modification units return a signal indicating the reaching of the desired state.

A simple reprogramming of the entire device is thus possible. Different sets of modes of operation of the entire system can also be kept ready for retrieval in the central control unit.

Through the design of the device according to the invention, it is easier to determine through trials the optimum settings for the overall operation of the device.

The regulating units each contain in a manner known per se a sensor for the instantaneous value of a parameter to be set and setpoint values for this parameter. The bringing of the instantaneous value up to the setpoint value takes place locally. The central controller needs only to preset the setpoint values.

It is understood that this setpoint value can include not only directly a physical parameter such as temperature, pressure, viscosity of the application material, flow rate of the application material, level of a material. Groups of such physical parameters can also be combined to form a virtual parameter which indicates whether and to what extent the various parameters are brought up to their setpoint values. Preferably, the central control unit transmits to the regulating units respectively only a single setpoint value for a particular desired operating state, and the regulating unit itself contains tables of setpoint values for physical parameters which are to be set in a desired mode of operation.

Further advantageous developments of the invention are discussed below.

According to a further development of the invention the conveying unit may include a controllable regulating unit which cooperates with a central control unit which is advantageous with regard to a simple and reliable setting of different modes of operation of the conveying unit, in particular also for control of a booster pump, which is a component of the conveying unit.

According to another development of the invention the modification units may have at least one valve arrangement which preset a part of the path on which the flow of the application material is conveyed which allows different flow paths of the processing material to be preset for different modes of operation.

According to a further development of the invention, the valve arrangement may preset an operating flow path which leads from a storage container via the application unit back to the storage container which allows easy presetting of an operating flow path for the application material.

According to further developments of the invention, the valve can preset at least one standby flow path which leads from the storage container via the conveying unit back to the storage container or leads from the conveying unit to the application unit and from the latter back to the conveying unit. The valve arrangements may also preset a short-circuit flow path which leads from the outlet of the conveying unit back to the inlet thereof. The modification units may include at least one of a pressure regulating unit, a heating unit, a mixing unit, a stirring unit, a degassing unit, a flow divider unit, a positioning unit, and/or a valve unit. Presetting one or both of these flow paths and/or providing the modification unit with the mentioned additional elements may allow only the lines normally subjected to high pressure or only the lines normally subjected to low pressure, or the conveying unit, to be set separately as a circulation path for application material. This may be advantageous because the line cross-sections of these lines and their geometries as well as the ambient temperatures to which they are exposed may differ.

According to yet a further development of the invention, the modification units may include at least one of a pressure regulating unit, a heating unit, a mixing unit, a stirring unit, a degassing unit, a flow divider unit, a positioning unit, and/or a valve unit which can be used particularly advantageously in connection with the invention.

According to yet another development of the invention, that the inlet of the conveying unit may be selectively connectable to one of a plurality of storage containers which makes it possible to choose between a plurality of application materials to be used. This also enables a replacement of a storage container to take place without interruption of the material dispensing.

According to yet another development of the invention, at least one modification device may include a controllable regulating unit to change the position of the application unit by moving the application into different positions which are adopted in breaks in operation or during application.

According to a further development of the invention, the control unit may be combined with the conveying unit to form an assembly which is advantageous with regard to a simple and compact structure of the device and with regard to a simple mounting of the same at the site of use.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

The invention is explained in more detail below using exemplary embodiments with reference to the accompanying drawing, in which:

FIG. 1 shows a circuit diagram of a system for coating workpieces with an application material having a high viscosity; and

FIG. 2 shows a schematic representation of a modification unit of the system according to FIG. 1.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated

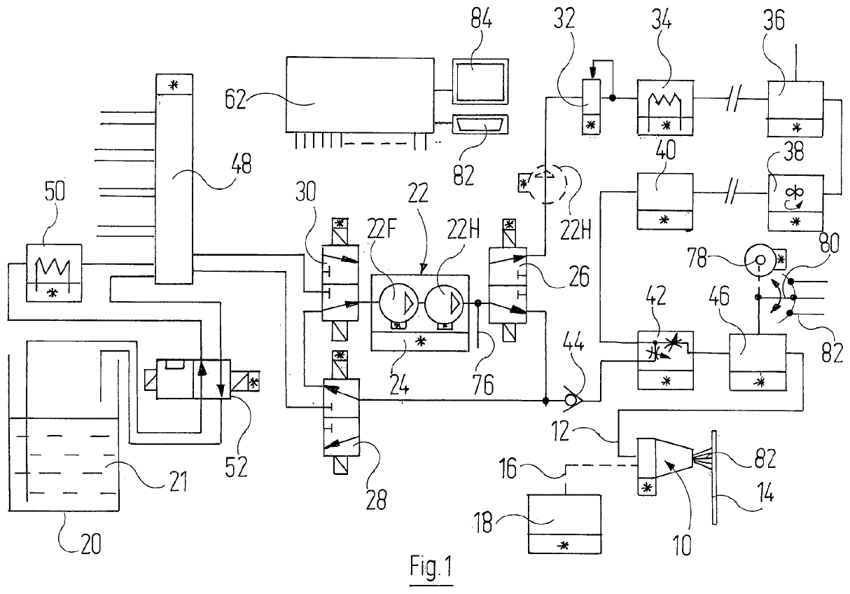

In FIG. 1, numeral 10 designates an application head, to which is supplied via a line 12 an application material which is to be applied to the surface of a workpiece 14.

The application head 10 is seated on the arm 16, indicated dashed, of a robot 18.

A material 21 to be applied is located in a storage container 20 and is fed by a conveying unit, designated as a whole by 22, into the line 12 under such a pressure level as is prescribed for the respective application head 10.

The conveying unit 22 may in practice be a pump combination which comprises a low-feed pump 22F and a high-pressure pump 22H. These pumps are chosen with regard to the properties of the application material. They may in particular be thick matter pumps.

The conveying unit 22 is assigned a controllable regulating unit 24 which controls the operation of the conveying unit 22, in particular presets which of the pumps contained in it is to operate in each case and what pressure and feed rate are to be provided overall. The operation of the regulating unit will be explained in more detail below with reference to FIG. 3.

To the outlet of the conveying unit 22 is connected a 3/2-solenoid valve 26 in the manner shown in the drawing. In the position of the solenoid valve 26 shown in the drawing, the outlet of the conveying unit 22 is connected to its inlet via two further 3/2-solenoid valves 28, 30.

In the second position, not shown in the drawing, of the solenoid valve 26, the outlet of the conveying unit 22 is connected to a pressure regulator 32.

Following the pressure regulator 32, as seen in the flow direction of the application material, is a heating unit 34, then a mixing unit 36, a stirring unit 38, a degassing unit 40 and a flow divider unit 42. One outlet of the latter is connected via a check valve 44 to the line which leads from the solenoid valve 26 to the solenoid valve 28.

A second outlet of the flow divider unit 42 is connected to the inlet of a further mixing unit 46, the outlet of which is connected to the line 12.

As can be seen from the drawing, the solenoid valve 26 serves to connect the suction side of the conveying unit 22 selectively to the delivery side thereof, as described above, and via a material changing unit 48 to the storage container 20. A further heating unit 50 and a further 3/2-solenoid valve 52 are inserted into the line leading from the material changing unit 48 to the storage container 20.

As FIG. 1 shows, a second outlet of the solenoid valve 28 is likewise connected to the material changing unit 48 and leads back to the storage container 20 via the solenoid valve 52. The position of the solenoid valve 52 shown in the drawing is that which is assumed during normal operation in order to convey application material from the storage container 20 to the application head 10.

In a second position, not assumed in FIG. 1, the solenoid valve 52 connects the return line and the suction line at the storage container 20.

If the valve positions shown respectively in the drawing are designated by “+” and the other valve positions by “−”, the following circuits can be set in the system shown in FIG. 1:

The head-side circuit: solenoid valve 26 “−”, solenoid valve 28 “+”, solenoid valve 30 “+”.

Pump circuit: solenoid valve 26 “+”, solenoid valve 28 “+”, solenoid valve 30 “+”.

Reservoir-side circuit: solenoid valve 26 “+”, solenoid valve 28 “−”, solenoid valve 30 “−”, solenoid valve 52 “−”.

Operating circuit: solenoid valve 26 “−”, solenoid valve 28 “−”, solenoid valve 30 “−”, solenoid valve 52 “+”.

The various units which undertake the temperature, composition, mixing, degassing and distributing of the application material are respectively assigned a controllable regulating unit which is constructed logically similarly to that for the conveying unit 22. These units are designated by the symbol “*” for greater clarity.

Where individual ones of these units are referred to below, this is done by indicating the reference character of the associated modification unit supplemented by the symbol “*”.

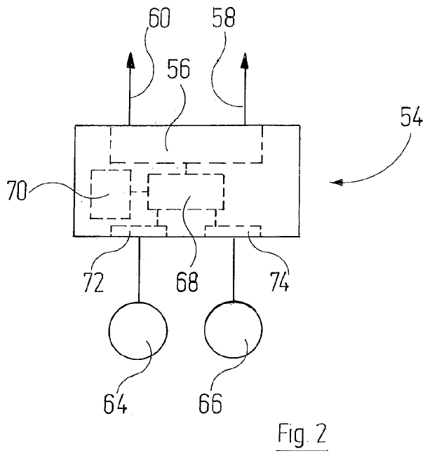

FIG. 2 shows schematically a regulating unit 54. It comprises a data communication module 56 with antennas 58 and 60 which serve for receiving and transmitting data to a central control unit, which is shown in FIG. 1 at 62.

A sensor 64 and an actuator 66 are connected to the regulating unit 54. There may also be a plurality of sensors and a plurality of actuators here. For example, the sensor 64 may be a temperature sensor and the actuator 66 a heater. Alternatively, the sensor 64 could measure the viscosity of the application material and the actuator 66 could either likewise be a heater or else an admixing valve, via which an evaporating medium is supplied to the application material. Any combination of sensors and actuators which can detect or influence the processing material in its chemical or physical properties is conceivable. Also the presetting of a particular flow path can be understood as a modification.

Typical sensors are sensors for temperature, pressure, viscosity, flow rate, levels, properties of the deposited layer of the application material etc. Typical actuators are heaters, mixers, setting elements which determine the feed pressure of a pump, valves for refilling the storage container, valves which can unblock and block the flow paths, etc.

The regulating unit 54 comprises a process computer 68 which cooperates with a data memory 70. If the process computer 68 receives, via the communication module 56, a digital command which has been agreed as a code for a specific desired mode of operation, the process computer 68 loads from the data memory 70 those setpoint values which are provided for this mode of operation.

The process computer 68 then controls the actuator 66 in such a way that the difference between the output signal of the sensor 64 and the prescribed setpoint value is minimised.

This applies mutatis mutandis to the case where the regulating unit 54 cooperates with a plurality of sensors and if necessary also a plurality of actuators. Included here is the case where the output signals of a plurality of sensors control a number of actuators which may be less than the number of sensors, but also greater than this.

In FIG. 2, 72 denotes an interface via which the process computer 68 controls the actuator 66, and 74 denotes an interface via which the process computer 68 cooperates with the sensor 66.

As can be seen from FIG. 1, the application head 10 can be connected to different storage containers via the material changing unit 48. Conversely, still further working heads 10 can be connected to the conveying unit 22, as indicated by a branch line 76. The further application heads and modification units upstream thereof can be treated logically in the same way as the further modification units which would be upstream of the working head 10.

In a modification of the above-described exemplary embodiment, the high-pressure pump 22-H can also be placed downstream of the solenoid valve 26, as shown dashed in FIG. 1.

An inlet of the mixing unit 46 is connectable, via a change-over switch 80 driven by a motor 78, to a plurality of lines 82, via which different liquids can be added to the application material. These are in particular reagents which initiate, promote or bring about the curing of the application material. Again there is provided a regulating unit * which shows the construction according to FIG. 2.

A control panel 82 and a monitor 84 are connected to the control unit 62.

The above-described application system operates as follows:

Mode of Operation

The valve 52 is in the “+”-position. The valve 30 is in the “−”-position, as is the valve 28. The valve 26 is in the “−” position.

The various modification units 32, 34, 36, 38, 40, 42 receive from the controller 62 signals “1” which set them to the mode of operation (mode 1). The various modification units then load from their memories 70 those setpoint values which are desired for dispensing the application material. They then actuate the actuators 66 respectively in such a way that the setpoint value is reached. At the inlet of the application head 10 there is thus obtained an application material which corresponds to the presettings in composition, pressure, temperature, viscosity, homogeneity and freedom from gas, and also in quantity. This material is dispensed as spray 82.

Application material not required by the application head 10 is returned from the flow divider unit 42 to the storage container 20 via the check valve 44, the solenoid valve 28, the changing unit 48 and the solenoid valve 52.

2. Application Head Circuit

In this mode of operation, the solenoid valve 30 is in the position “+”, the solenoid valve 26 is in the position “−” and the solenoid valve 28 is in the position “+”. The suction side of the conveying unit 22 is thus directly connected to the material return. The material is conveyed from the conveying unit 22 to the application head 10 and from there back to the conveying unit 22 again.

In this way, the application material is circulated in the part of the system which is under high pressure and keeps the corresponding line sections open throughout.

3. Low-Pressure Range Circuit

In this mode of operation, application material is moved between storage container 20 and the conveying unit 22. For realisation the solenoid valve 30 is in the position “−”, the solenoid valve 26 is in the position “+”, the solenoid valve 28 is in the position “+” and the solenoid valve 52 is in the position “−”. The application material is thus circulated only in that part of the system in which low pressure prevails.

Optionally, in this mode of operation the solenoid valve 52 may also be left in the position “+”, so that the circulated material is returned to the storage container 20 and is sucked out of the latter again by the conveying unit 22.

4. Pump Circuit

In this mode application material is circulated only by the conveying unit 22. For this purpose, the solenoid valve 30 is in the position “+”, the solenoid valve 26 is in the position “+” and the solenoid valve 28 is in the position “+”.

In all of the circuits 2. to 4. just described, the pressure and/or the flow rate can be modified, usually reduced, compared with those of the operating circuit. In these circuits it is also possible, if necessary, to bypass the high-pressure pump 22H by a controllable bypass.

In the above-described application system, all system parts which modify the ways in which application material is conducted, and all units which modify the quality of the application material, can be dealt with logically equally. In this way, both the programming of the controller 62 and the optimising of the different parameters which determine the application result can be effected in a simple manner.

The above statements can be summarised as follows:

An application system or a device for providing application material comprises at least the following assemblies/system parts:
a) supply/provision of the application material,
b) transport and conveyance of the application material from the source to the place of consumption/place of use,
c) pump for increasing the pressure which the application material is under,
d) an application unit for applying the application material to a workpiece,
e) optionally modification units for the application material which can be arranged upstream or downstream of the conveying unit.

By application material there are to be understood all materials which are suitable/intended for application to a workpiece. These are in particular paints, waxes, adhesives, underbody protection materials, anti-drumming materials, sealing materials, etc.

It is, however, also possible according to the invention to control other liquid flows in an application system, in particular individual components from which the application material is mixed together.

The typical consistency of the application material ranges from pasty, gel-like and highly viscous to low-viscous liquids.

The application itself can be effected continuously or in sections. The application material can be automatically or manually applied to the workpiece. When reference is made herein to workpiece, workpiece sections are also always to be understood by this.

The invention is concerned primarily with the application of materials to vehicle components.

The workpieces are not limited to those which are produced from particular materials. The processing state of the workpieces may also vary. A workpiece may be an unfinished component or a finished component. Thus, for example, adhesive uses on unfinished vehicle components as well as on finished vehicle components (gluing in a pane) are possible.

The conveying unit located in the system and the modification units provide, through integrated or directly mounted, tuned sensors and actuators and the associated evaluation logic, a convenient and simple way of optimising the quality of the operation of the system.

For this purpose, the system typically comprises: interfaces for acquisition/feedback of measured values or control signals for the conveying unit, the application unit, the modification units and the source for the application material. These include temperature values, pressure values, viscosity values, flow rate values and objects.

Via the interfaces, an exchange of control signals and data is effected in such a way that the behaviour of the conveying unit corresponds to the prevailing conditions of the mode of operation, in particular the conditions in the high-pressure part and in the low-pressure part of the system.

Thus, it can be brought about that the conveying device switches from one storage container to a second storage container when the storage container reaches a lower permissible filling level.

The pump parameters can be set so that in the direction towards the application unit a trouble-free further operation is ensured on switching to another source of material.

There are further provided interfaces which serve for acquisition/feedback of measured values or control signals of the application unit. These are, for example, temperature values, pressure values, viscosity values, flow rate values and cycle times. These interfaces allow an exchange of control signals and/or data, in order for the behaviour of the conveying unit, in particular the operation of the pressure pump of the same, to comply with the required conditions in the application device.

There are further provided interfaces and sensors to report trouble in the material supply and/or the modification units and/or the application units, which then allows the operating parameters of the conveying unit and/or of the modification units and/or of the application units to be adjusted so that the operation of the system is maintained and as far as possible a trouble-free further operation is ensured.

The pump parameters can also be changed in dependence on the output signals of sensors belonging to the conveying unit, and with the inclusion of further process parameter-detecting sensors. Such control signals and control data can also be provided, for example, by the modification units.

In the application system according to the invention, the conveying path parameters can also be influenced: further conveying paths can be connected and disconnected, the flow of the application material can be controlled and also the pressure which the application material is under can be preset.

As stated above, the admixing or removal of components of the processing material is possible. Thus, for example, in one mixing unit of a binder component of an adhesive material a hardener component can be admixed. In another modification unit a parameter which was previously set higher only to establish better conveying properties can be reset. Thus, for example, the temperature of the application material can, for conveying purposes, be increased more intensely than required in the application unit and a cooling unit can be provided directly upstream of the application unit.

To coordinate the operation of the different system parts, a hierarchically higher-level central controller is provided. Since the different system parts have local intelligence, it is sufficient if the central control unit presets only a few external parameters for the system parts, e.g. cycle presettings or workpiece types. A reprogramming of the system is simplified by this division of tasks between central and local intelligence. It is thus also possible through trials easily to find the respectively optimum operating conditions for the entire system.

The installation of the system at a site of use is simple and clear, since the system is independent and no additional interfaces and/or data converters necessitating a connection to an external controller are required.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A device for providing an application material comprising:
an application head;
a conveying unit for conveying application material from a material source to the application head; and
a plurality of modification units, the conveying unit and the plurality of modification units each comprising a regulating unit which sets, checks, and maintains operating parameters according to a control signal received from a central control unit, the control signal setting a mode of operation from a plurality of discrete modes of operation which are stored within the regulating units,
wherein one discrete mode of operation from the plurality of discrete modes of operation sets a subset of the modification units to form a flow path for the application material from an outlet of the conveying unit back to the inlet of the conveying unit so that application material is only conveyed through the conveying unit and the subset of modification units.

2. The device according to claim 1, wherein the plurality of modification units have at least a second discrete mode of operation which presets a second flow path along which the application material is conveyed from the conveying unit to the application head and back again.

3. The device according to claim 1, wherein the plurality of modification units have at least a second discrete mode of operation which presets a second subset of the plurality of modification units to form a second flow path along which the application material is conveyed from the material source to the application head and back again.

4. The device according to claim 1, wherein the plurality of modification units have at least a second discrete mode of operation which presets a second subset of the plurality of modification units to form a second flow path along which the application material is conveyed from the material source to the conveying unit and back again.

5. The device according to claim 1, wherein the plurality of modification units comprise at least one unit having an actuator listed in the following group: a pressure regulator, a heater, a mixer, a flow divider, an arm and robot combination, a or valve unit.

6. The device according to claim 1, wherein the inlet of the conveying unit is selectively connectable to one of a plurality of storage containers.

7. The device according to claim 1, wherein the central control unit is combined with the conveying unit to form an assembly.

8. A device for providing an application material comprising:
an application head;
a conveying unit for conveying application material from a material source to the application head; and
a plurality of modification units, the conveying unit and the plurality of modification units each comprising a regulating unit which sets, checks, and maintains operating parameters according to a control signal received from a central control unit, the control signal setting a mode of operation from a plurality of discrete modes of operation which are stored within the regulating units,
wherein the plurality of modification units comprises a first modification unit, a second modification unit, and a third modification, wherein
the first modification unit is connected to an inlet of the conveying unit,
the second modification unit is connected to an outlet of the conveying unit, and
the third modification unit is connected to an outlet of the second modification unit and an inlet of the first modification unit, and
one discrete mode of operation from the plurality of discrete modes of operation sets the first, second, and third modification units to form a flow path for the application material from the outlet of the conveying unit back to the inlet of the conveying unit so that application material is conveyed from the outlet of the conveying unit to the second modification unit, from the second modification unit to the third modification unit, from the third modification unit to the first modification unit, and returns from the first modification unit to the inlet of the conveying unit.

9. A device for providing an application material comprising:
an application head;
a control unit, the control unit producing and transmitting control signals for setting a plurality of discrete modes of operation;
a conveying unit for conveying application material from a material source to the application head, the conveying unit having a first controllable regulating unit assigned to the conveying unit for receiving the control signals and adjusting the operation of the conveying unit accordingly;
a plurality of modification units, each modification unit having a controllable regulating unit assigned thereto for receiving the control signals and adjusting the operation of the associated modification unit accordingly,
wherein the plurality of modification units comprises a plurality of valves, each valve having at least two valve positions, wherein the plurality of valves set a plurality of flow paths for the application material, the plurality of discrete modes of operation comprising at least
a first mode of operation wherein the plurality of valves set a flow path from the material source to the application head;
a second mode of operation wherein at least a first portion of the plurality of valves set a closed-circuit flow path between the conveying unit and the application head so that the application material is conveyed from the conveying unit to the application head and back again;
a third mode of operation wherein at least a second portion of the plurality of valves set a closed-circuit flow path between the material source and the conveying unit so that the application material is conveyed from the material source to the conveying unit and back again; and
a fourth mode of operation wherein at least a third portion of the plurality of valves set a closed-circuit flow path from an outlet of the conveying unit to an inlet of the conveying unit so that application material is only circulated through the third portion of the plurality of valves and the application head.
